(19) United States
(12) Patent Application Publication
(10) Pub. No.: US 2012/0186032 A1
(43) Pub. Date: Jul. 26, 2012

(54) Adjustable bolt cleaner

(76) Inventors: William J. Donohue, Dillon, CO (US); Matthew Stroh, Dillon, CO (US)

(21) Appl. No.: 12/931,080

(22) Filed: Jan. 24, 2011

(51) Int. Cl. B23D 79/02

(52) U.S. Cl. 15/93.1

(57) ABSTRACT

A adjustable fitting thread cleaning apparatus. The apparatus is specifically used for cleaning the threads of bolts. Bolts of any type namely ones used in the field of autos, machinery and equipment. The apparatus consists of 2 parallel elements that form an inner adjustable diameter. Parallel elements adjust from 7.5 mm to 30 mm in diameter for cleaning bolts in this size range. The apparatus consists of a shaft member with the purpose of connecting to a power drill to be rotated at high velocity speed. This creates an expeditiously quick and thorough clean of the bolt threads when the bolt is inserted in between the parallel elements.

### CROSS-REFERENCE TO RELATED APPLICATIONS

Not Applicable

### FEDERALLY SPONSORED RESEARCH

Not Applicable

### SEQUENCE LISTING PROGRAM

Not Applicable

### BACKGROUND

1. Field

The present invention relates to apparatuses used for cleaning, more particularly apparatuses used for cleaning the threads of bolts.

2. Prior Art

The related art of interest describes various thread cleaners. Each apparatus completes its particular method of cleaning the threads of bolts but the need remains for a apparatus having a more thorough contact with the threads of bolts with adjustable fitting combined with the high velocity rotation by connection of a power drill for a expeditiously quick and thorough clean of bolts varying in thread size, type and diameter.

U.S. Pat. No. 6,983,508 to Saurer (2006) describes a thread cleaning apparatus with a shaft member for connection to a power drill but lacks the novel ability of adjustable fitting. This apparatus is therefore confined to a particular diameter fitting unable to adjust to meet the varying diameters of bolts or other threaded elements. In addition to this it also does not comprise a suitable amount of bristles that are used for cleaning for a more thorough contact being elongated to fit the length of a bolt that would result in a quicker and more efficient clean.

U.S. Pat. No. 7,418,756 to Ortega (2008) describes a thread cleaner with the ability to adjust to engage the diameter of a bolt. However it lacks the novel ability of a shaft member for the purpose of connecting to a power drill for a high velocity rotation. The ability of high velocity rotation would create a thorough and quick clean of the threads. Since this apparatus does not comprise this feature it becomes a more time consuming process of cleaning threads as it uses the particular method of using a wrench to drive the bolt through the thread cleaners. In addition to this the thread cleaners of this apparatus are not bristles and its thread cleaners are segregated to a smaller surface contact which is not elongated. This does not provide thorough contact of the length or diameter of a bolt that would inevitably result in a quicker and more thorough clean if it had more surface contact.

### SUMMARY

The present invention meets the needs of cleaning the threads of bolts quickly and thoroughly while being able to quickly adjust to fit the diameter of a bolt in the diameter range of 7.5 mm to 30 mm. Having 2 parallel elements which are characterized by a plethora of flexible bristles intended for scrapping away corrosion and build-up from the threads of bolts. The elements are elongated and extend from the body portion maintaining a parallel unison forming a inner adjustable diameter in order to fit the threaded portion of a bolt. The body portion of the apparatus has a rotary member that rotates clockwise and counter clockwise thus expanding and contracting the elongated elements to engage the diameter of a bolt. Connected to the body portion at the opposite end of the elongated elements is a shaft member for the purpose of connecting to a power drill in order for the apparatus to be rotated at high velocity speed while engaging the threaded portion of a bolt.

### DRAWINGS

### Figures

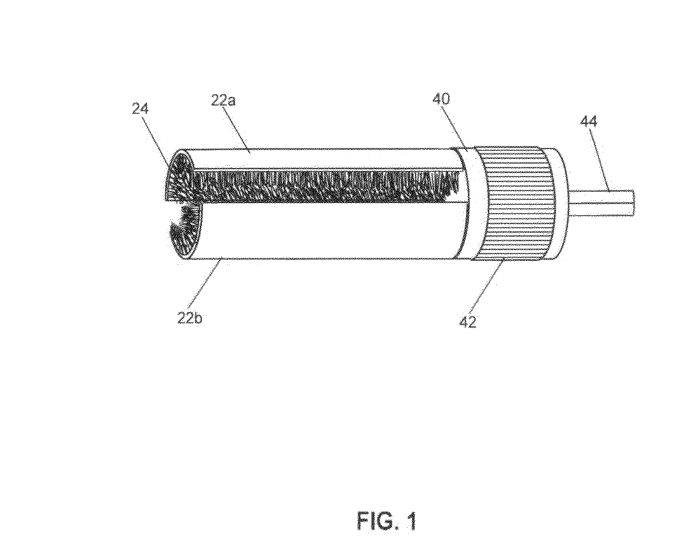

FIG. 1 shows a perspective view of the apparatus

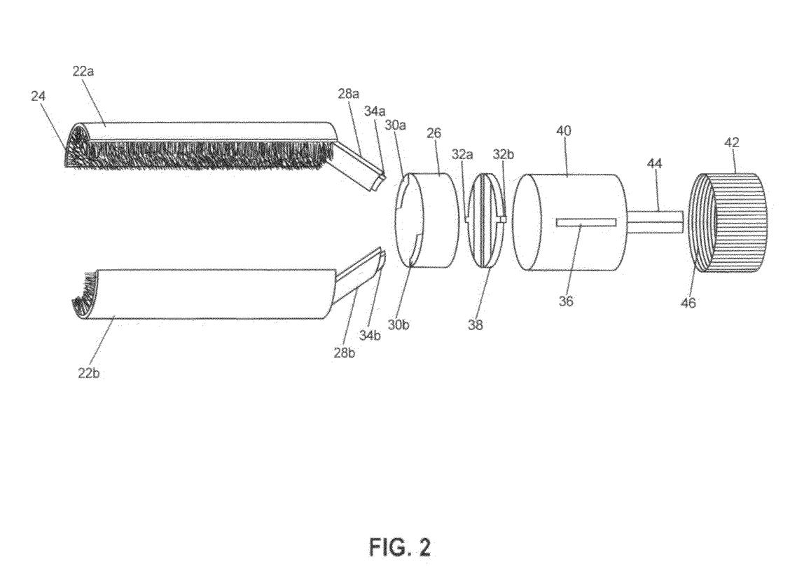

FIG. 2 shows a exploded view of the apparatus

DRAWINGS—Reference Numerals

| 22a | Parallel Element | 22b | Parallel Element |
|---|---|---|---|
| 24 | Bristles | 26 | Collar |
| 28a | Angled Arm | 28b | Angled Arm |
| 30a | Shaft | 30b | Shaft |
| 32a | Thread Connectors | 32b | Thread Connectors |
| 34a | Rail Connectors | 34b | Rail Connectors |
| 36 | Elongated Opening | 38 | Rail Plate |
| 40 | Housing | 42 | Adjuster |
| 44 | Shaft Member | 46 | Threads |

### DETAILED DESCRIPTION

### FIGS. 1 and 2—Preferred Embodiment

As best illustrated in FIG. 1 and FIG. 2 the apparatus comprises a shaft member 44 for connecting to a power drill. Two parallel elements 22a, 22b comprise a plethora of bristles 24. Each parallel element 22a, 22b form a semi circular circumference extending 2 inches in length from top to bottom. Parallel elements 22a, 22b comprise angled arms 28a, 28b. These angled arms 28a, 28b are designed to slide through a collar 26. The collar 26 comprises solid steel with shafts 30a, 30b bored through at an angle. At the base of the angled arms 26a, 26b are rail connectors 34a, 34b. The rail connectors 34a, 34b attach to the rail plate 38. The collar 26 and the rail plate 38 fit inside the apparatus housing 40. The rail plate 38 comprises thread connectors 32a, 32b extending outward on each side of the rail plate 38. Apparatus housing 40 comprises two parallel elongated openings 36 on each side for the thread connectors 32a, 32b to extend out to meet a threaded portion 46 of a adjuster 42 for adjustment purposes.

### Operation—FIGS. 1 and 2

In use the thread connectors 32a, 32b which are connected to the rail plate 38 are either pushed up or pulled down by the threads 46 of the adjuster 42 when the adjuster 42 is rotated either clockwise or counterclockwise thus moving the rail plate 38 up or down. When the rail plate 38 moves up it pushes the angled arms 28a and 28b up and through the shafts 30a and 30b of the collar 26. Whereby expanding the diameter between the parallel elements 22a and 22b to meet the diameter of a particular bolt. When the rail plate 38 moves down it pulls the angled arms 28a and 28b down and through the shafts 30a and 30b of the collar 26. Whereby contracting the diameter between the parallel elements 22a, 22b to meet the diameter of a particular bolt. The angled arms 28a, 28b are directly connected to the rail plate 38 by the rail connectors 34a, 34b which slide along the rail plate 38 to compensate for the expanding diameter.

### Advantages

From the description above advantages become evident:

(a) Optimum dimensional design allows for quick adjustment of the diameter between the parallel elements to engage varying diameters of bolts.

(b) The parallel elements are elongated to provide the ability to clean long bolts or short bolts varying in thread size and diameter.

(c) Apparatus comprises a plethora of flexible bristles attached to elongated parallel elements for a thorough contact of the threads of bolts.

(d) Apparatus comprises a shaft member for connecting to a power drill for a expeditiously thorough and quick clean of a bolt.

It is to be understood that these certain optimum dimensional relationships readily provide advantageous means of cleaning the threads of bolts varying in size, type and diameter.

We claim:

1. A rotary adjustable apparatus for cleaning the threads of bolts comprising;
a. a body portion characterized by adjustable elements extending from said body portion forming an inner adjustable diameter wherein the threaded end of a bolt will be inserted;
said adjustable elements have bristles attached whereby said bristles are intended for scrapping away the corrosion and build-up from said threads of bolts;
b. means for adjusting said adjustable elements;
c. a shaft member connected to said body portion at opposite end of said adjustable elements intended for connecting to power drill wherein said apparatus will be rotated at high velocity speed.
